(19) United States
(12) Patent Application Publication
(10) Pub. No.: US 2020/0360969 A1
(43) Pub. Date: Nov. 19, 2020

(54) COFFEE BEAN SORTING SYSTEM HAVING ROTARY DISK

(71) Applicant: AVITONE CO., LTD., New Taipei City (TW)

(72) Inventors: WEI-CHENG LIEN, New Taipei City (TW); Yu-Shao Chiu, New Taipei City (TW); Chuang-Ming Chiu, New Taipei City (TW)

(73) Assignee: AVITONE CO., LTD., New Taipei City (TW)

(21) Appl. No.: 16/874,668

(22) Filed: May 14, 2020

(30) Foreign Application Priority Data
May 17, 2019 (TW) 108117149

(51) Int. Cl. B07C 5/342; A23N 15/00; A23F 5/02; B07C 5/36; G06K 9/62

(52) U.S. Cl. CPC B07C 5/3422; A23N 15/00; A23F 5/02; G06K 2209/17; B07C 5/365; G06K 9/6256; A23N 2015/008; B07C 5/3425

(57) ABSTRACT

A coffee bean sorting system has a feeding mechanism, a rotary disk, at least one image capture device, an information processing device, and a removal mechanism. The rotary disk can receive coffee beans transported from the feeding mechanism, and can rotate along an axis thereof, such that the coffee beans are spaced apart from each other and form a succession. The image capture device can capture an initial image of each of the coffee beans. The information processing device can perform machine learning training or deep learning training function, identify each of the initial images, and after determining a coffee bean is non-conforming, make the removal mechanism to remove the non-conforming coffee bean.

### CROSS-REFERENCE TO RELATED PATENT APPLICATION

This non-provisional application claims priority to and the benefit of, under 35 U.S.C. § 119(a), Taiwan Patent Application No. 108117149, filed in Taiwan on May 17, 2019. The entire content of the above identified application is incorporated herein by reference.

### FIELD

The present disclosure is related to a coffee bean sorting system, and more particularly to a coffee bean sorting system having a rotary disk.

### BACKGROUND

Many medical journals have pointed out that coffee has various ingredients that are beneficial to the health of the human body, such as caffeine, which can vitalize the central nervous system and can resist fatigue, lower the chance of common cold, colds, and reduce the occurrence of asthma and edema; antioxidants, which can slow down the deterioration of liver disease, lower the prevalence rate of chronic liver disease, and reduce the risk of death of the complications of hepatic cirrhosis; anti-dementia substances, which can reduce the impact of harmful substances on the body and lower the content of dementia-causing amyloid in the human brain; and polyphenolic compounds, which can delay the oxidation of low-density lipoprotein and dissolve blood clots and prevent thrombi. Therefore, as the benefits of coffee are disclosed one after another, the coffee drinking population has gradually increased, and the coffee culture has developed accordingly.

Generally speaking, to keep the flavors and quality of coffee after roasting, current manufacturing processes of coffee beans typically have such steps as “grading” and “sorting”, etc. “Grading” is to sort coffee beans into different grades according to their appearances and sizes so that the coffee beans in each grade have consistency, so as to add to product value and help maintain the consistency of coffee bean quality when coffee beans are subsequently roasted. “Sorting” is to pick out foreign matter and defective beans. Foreign matter includes foreign substances that are not coffee beans, such as stones, wood chips, soil particles, etc. Defective beans include, for example, as listed by Specialty Coffee Association of America (SCAA), black beans, sour beans, dried cherry/pod, fungus damaged beans, insect damaged beans, broken beans, immature beans, withered beans, shell beans, floater beans, parchment beans, hull, quakers, etc. After all, if coffee beans for sale include defective beans, not only will the flavors of coffee be affected, but in serious cases, injury to the human body may result. For example, fungus damaged beans may produce aflatoxin.

Nowadays, in addition to manual selection, the sorting methods of coffee beans include machine-assisted selection; for example, some manufacturers choose to use specific-weight bean screeners, which by means of wind power or vibration, classify coffee beans according to their particle sizes and weight. However, the sorting method of a specific-weight bean screener can only provide preliminary classification but cannot effectively sort out defects in color, such as partial fungus damage, black beans, etc. To solve the aforesaid problems, some manufacturers choose to use color screeners to sort out foreign matter and defective beans according to the colors of coffee beans. For example, a conventional color sorter (such as Taiwan Patent No. 375537), during a process in which the coffee beans are falling, captures an image of coffee beans, in order to perform identification and at the same time remove foreign matter and defective beans therein. However, as each coffee bean has a different weight and consequently a different falling time, it is difficult to control the timing of removal precisely; moreover, during the falling process, it is often that a plurality of coffee beans block one another, causing situations of misjudgment, leading to an undesirable sorting result.

Aside from the aforesaid color screener that performs sorting during a falling process, Taiwan Patent No. M570428, for example, provides another kind of color screener, which provides a transparent, spirally inclined surface on a vibrating table, and uses the vibrating effect of the vibrating table to push coffee beans onto the spirally inclined surface, so as to have images taken and be sorted. While the aforesaid color screener aims to the problems deriving from sorting during a falling process, in terms of implementation and use, the aforesaid color screener still has many problems. First, the vibrating table is generally made of a metal material, so making the vibrating table in conjunction with an additional transparent material is extremely complicated in craftsmanship and is difficult to commercialize. Second, the vibrating table, during the vibrating conveying process, transports coffee beans by its vibrating and pushing; therefore, in actuality, coffee beans may still pile up easily. In particular, when the spirally inclined surface is relatively narrow and small, coffee beans are more likely to pile up, affecting the quality of the images captured.

Continued from the above, the aforesaid color screeners rely only on colors to achieve the effect of defective bean identification but cannot sort out defective beans whose colors are similar to those of normal beans, such as broken beans, withered beans, etc. Hence, when there are a large number of defective beans, their judgment accuracy may be poor. Furthermore, as the area of the spirally inclined surface is relatively small, devices such as an image capture device, a removal device, etc. are subject to limitations imposed by the aforesaid narrow area, causing inconvenience in mounting and installation. Lastly, while the vibrating table keeps vibrating, coffee beans are vibrated along with it too, so images captured by the image capture device are usually not clear enough, which affects the defective bean identification result that follows.

It can be known from a synthesis of the above that devices currently used to sort coffee beans are less than perfect, so how to solve the aforesaid problems effectively is an important issue to be addressed in the present disclosure.

### SUMMARY

One aspect of the present disclosure is directed to a coffee bean sorting system having a rotary disk. The system includes a feeding mechanism, a rotary disk, at least one image capture device, an information processing device, and at least one removal mechanism. The feeding mechanism is configured to transport a plurality of coffee beans thereon. The rotary disk is configured to receive the plurality of coffee beans transported from the feeding mechanism, and rotate along an axis thereof, such that the plurality of coffee beans transported from the feeding mechanism are spaced apart from each other so as to be separate from each other and form a succession. The image capture device is configured to capture an initial image of each of the plurality of coffee beans. The information processing device is configured to receive the initial image sent from the image capture device. The information processing device includes an image database and a processing unit. The image database is stored with a plurality of coffee bean models and parameters. The processing unit is configured to compare the initial image against each of the coffee bean models and parameters, determine whether the each coffee bean is conforming based on the comparison, and in response to determining at least one coffee bean is non-conforming, generate a removal signal corresponding to the non-conforming coffee bean. The processing unit includes at least one of a learning module and a computing module, and can perform at least one of machine learning training function, deep learning training function and inference computing, so as to identify the non-conforming coffee bean. The removal mechanism is configured to receive the removal signal sent from the information processing device, so as to remove the non-conforming coffee bean.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a coffee bean sorting system according to the present disclosure.

FIG. 2 is a flowchart of the learning module executing a training stage according to the present disclosure.

FIG. 3 is a schematic diagram of the learning module executing feature identification according to the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way.

Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, parts or the like, which are for distinguishing one component/part from another one only, and are not intended to, nor should be construed to impose any substantive limitations on the components, parts or the like.

In recent years, with the rapid advancement in the field of artificial intelligence machine learning, the model training processes of machine learning and deep learning have been able to take into consideration various image features such as colors, shapes, spots, etc. at the same time and thereby effectively enhance the accuracy of image processing. So far, however, no actual products have incorporated the aforesaid artificial intelligence technology in order to be applied to the field of coffee bean sorting. Therefore, one aspect of the present disclosure is to integrate the artificial intelligence technology into a coffee bean sorting system.

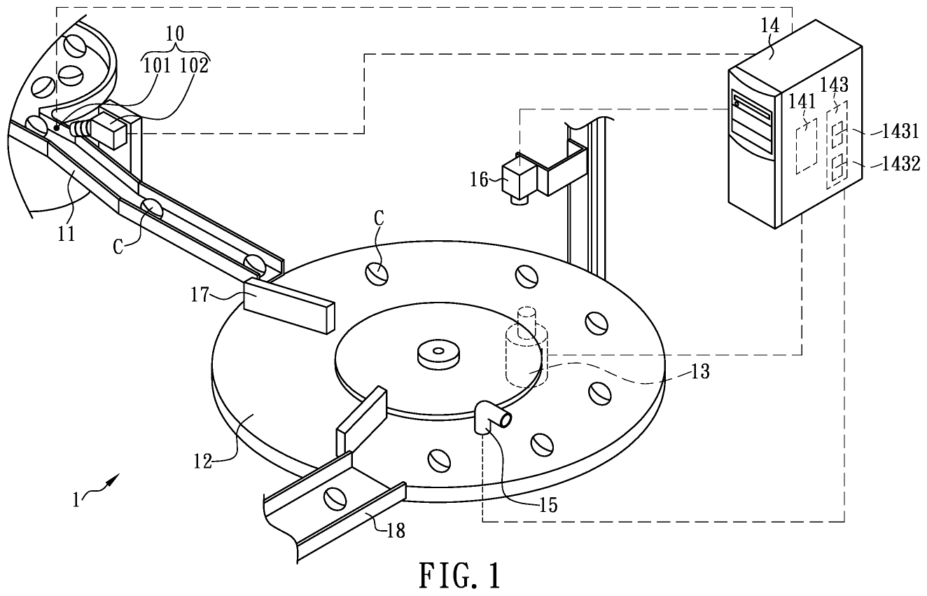

The present invention provides a coffee bean sorting system that has a rotary disk. Referring to FIG. 1, in certain embodiments, the coffee bean sorting system 1 at least includes a feeding mechanism 11, a rotary disk 12, at least one image capture device (e.g., a lower image capture device 13 and/or an upper image capture device 16), an information processing device 14, and at least one removal mechanism 15. The feeding mechanism 11 can transport a plurality of coffee beans C thereon to the rotary disk 12. It is noted that the feeding mechanism 11 may be a continuous track, a vibrating table, or other transporting mechanisms. Any feeding mechanism that can transport the coffee beans C to the rotary disk 12 is the feeding mechanism 11 referred to in the present disclosure.

With continued reference to FIG. 1, the rotary disk 12 can rotate along its own axis. When the plurality of coffee beans C are transported from the feeding mechanism 11 to the rotary disk 12, there is usually a sequential order, and the rotary disk 12 keeps rotating such that adjacent coffee beans C are spaced apart from each other. In addition, as the rotary disk 12 only rotates stably, it will not be affected by the transmission of the feeding mechanism 11. Therefore, when the coffee beans C leave the feeding mechanism 11 and are transported to the rotary disk 12, the coffee beans C will stay on the rotary disk 12. In this condition, the coffee beans C on the rotary disk 12 will not pile up but can be separated from one another and form a succession, and each coffee bean C can stay in a still or nearly still state. In certain embodiments, the rotary disk 12 is transparent (e.g., a glass material) to facilitate the image taking operation described further below. However, the present disclosure is not limited thereto, and a manufacturer may adjust the material of the rotary disk 12 according to practical needs.

With continued reference to FIG. 1, the image capture device can capture an initial image of a coffee bean C, and when the image capture device is at a position under the bottom side of the rotary disk 12, the image capture device can serve as the lower image capture device 13. Moreover, as the rotary disk 12 is made of a transparent material, the lower image capture device 13 can capture the initial image (hereinafter referred to as the bottom-side or first initial image) of a coffee bean C through the rotary disk 12. Since the coffee beans C on the rotary disk 12 are in a still state relative to the rotary disk 12, the bottom-side initial image can be relatively clear, which helps enhance the effect of subsequent identification. Further, the information processing device 14 can receive the bottom-side initial image transmitted from the lower image capture device 13. In certain embodiments, the information processing device 14 is provided therein at least with an image database 141 and a processing unit 143. For example, the information processing device 14 is provided therein with a memory unit, and the memory unit can be installed with (store) the image database 141. The image database 141 stores a plurality of coffee bean models and a plurality of parameters corresponding to the coffee bean models. The aforesaid coffee bean models and parameters may be related to the features of defective beans, or the features of coffee beans being subjected to different processing methods (e.g., sun exposure process, water washed process, seal process, etc.), or the features of different varieties of beans (e.g., Yirgacheff, Geisha, Hawaii Kona, etc.) or of different grades of coffee beans. That is to say, the coffee bean sorting system 1 in the present disclosure can, in addition to sorting out foreign matter and defective beans, classify or grade coffee beans.

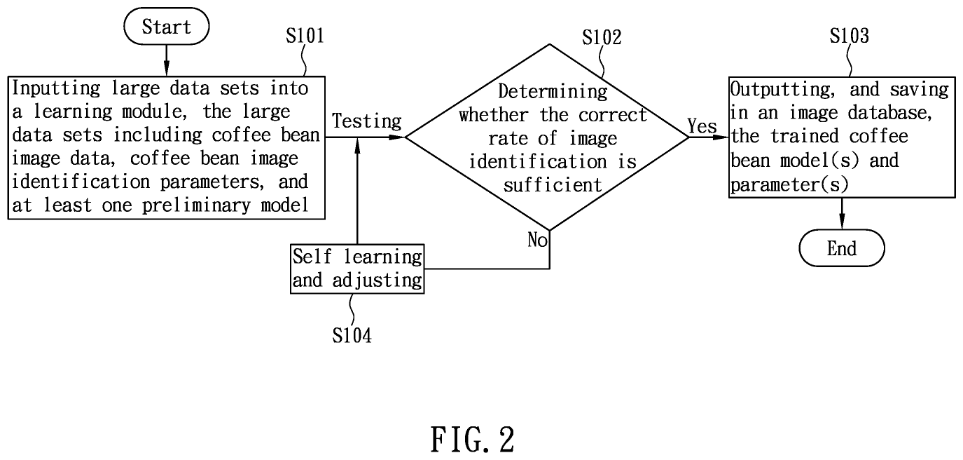

With continued reference to FIG. 1, the processing unit 143 may be a microprocessor. In certain embodiments, the processing unit 143 may be a central processing unit. The processing unit 143 may be electrically connected to the memory unit to read the contents of the image database 141. In certain embodiments, the processing unit 143 is built-in with at least one of a learning module 1431 and a computing module 1432. However, the learning module 1431 may be provided not in the information processing device 14. For example, the learning module 1431 may be provided in an information processing device (e.g., a computer) that is not the information processing device 14, provided that it can perform the functions described below. The term “module” may refer to or include, but not limited to, an electronic circuit; an Application Specific Integrated Circuit (ASIC); a combinational logic circuit; a processor that executes program code; or any suitable hardware component that provides the functionality described in the present disclosure. The term module may also include memory that stores program code executed by the processor. In certain embodiments, the learning module 1431 and the computing module 1432 may include codes that are stored in a memory unit and are used to perform the functions described below. The learning module 1431 can perform machine learning training or deep learning training so as to identify non-conforming coffee beans. In certain embodiments, referring to FIG. 2, at first the processing unit 143 can perform a training step, and input large data sets (as in step S101) and a preliminary an artificial intelligence learning model (for example, it can be based on a supervised and semi-supervised learning algorithm, a reinforcement learning algorithm, a convolutional neural network algorithm, a random forest algorithm, etc.) into the learning module 1431. The large data sets may include coffee bean image data and coffee bean image identification parameters. The coffee bean image data may be complete pictures or image information (e.g., color histograms, contours, spots, sizes, etc.) generated by subjecting a picture to an image processing method. The coffee bean identification parameters may be user-defined parameters such as manually set different-coffee-bean-conditions-corresponding models and weight values of their features. For example, if the black area of the outer surface of a coffee bean exceeds 50% of the entire surface area, the coffee bean will be categorized as a completely black bean; if the black area of the outer surface of a coffee bean is 5%˜50% of the entire surface area, the coffee bean will be categorized as a half-black bean; if there are 3 or more insect damage holes in the outer surface of a coffee bean and the diameters of the aforesaid holes are 0.3 mm-1.5 mm, the coffee bean is categorized as a seriously insect-damaged bean; if there are insect damage holes in the bean body but the number is less than 3, the bean is categorized as a slightly insect-damaged bean; and if there is one or more mold spots on the outer surface of a coffee bean, the coffee bean will be categorized as a fungus damaged bean.

With continued reference to FIG. 1 and FIG. 2, the learning module 1431 can test the correct rate of image identification in order to determine whether the correct rate of image identification is sufficient (as in step S102). For example, incessantly updating the weight values of the various coffee bean features of the model(s) so as for self-correction. For example, the learning module 1431 can, based on the aforesaid coffee bean image data and the aforesaid artificial intelligence learning model, actively generate the model(s) and standard(s) that have specific coffee bean feature weight values and can be used to sort normal beans and defective beans. Answer reference data corresponding to at least a portion of the aforesaid coffee bean image data can be stored in the memory unit and/or included in the inputted large data sets, and the learning module 1431 can compare the sorting result of the sorting model(s) and standard(s) it has established with the artificial intelligence learning model against the aforesaid answer reference data, and produce, according to the comparison result, the image identification correct rate of the sorting model(s) and standard(s).

When the determination result is that the image identification correct rate is sufficient, i.e., reaching a preset correct rate threshold value, the processing unit 143 outputs the related information (coffee bean model and parameters) that has completed training, and stores the information in the image database 141 (as in step S103); when the determination result is otherwise, the learning module 1431 performs self-correcting learning (as in step S104) by adjusting the image identification parameters or by other means. For example, the criteria by which the learning module 1431 sorts normal beans and defective beans in the first place is based on manual setting, and the aforesaid manual setting may include various detailed and specific information, or vague simple information. Then, during the learning process, in which image identification is carried out many times, the learning module 1431 can automatically adjust the criteria (e.g., change the weight values of the model(s)) until the image identification correct rate is sufficient. Thus, training is completed by repeating the aforesaid steps.

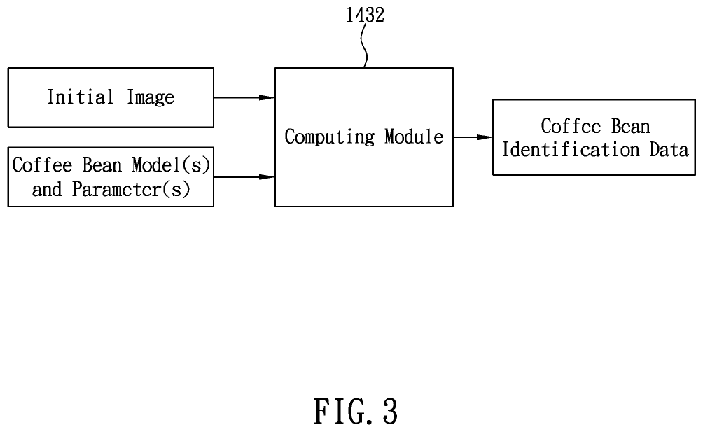

In certain embodiments, it is feasible that the processing unit 143 does not perform learning training but uses a trained model and trained weights for inference computing to identify coffee bean features. For example, the computing module 1432 can, based on the model and weight data that are learned in advance from another learning process similar to that shown in FIG. 2 and are stored in the image database 141, perform the feature identification step shown in FIG. 3 to identify coffee bean features.

Referring to FIG. 3, the processing unit 143 can perform a feature identification step. The computing module 1432 can receive an initial image (e.g., a bottom-side initial image) and the coffee bean model and parameters in order to carry out coffee bean image identification. The processing unit 143 inputs the bottom-side initial image into the trained coffee bean model and parameters; outputs the identification information of the coffee bean C, for example, information that is sufficient for performing defect or grade classification on the coffee bean C such as whether the coffee bean C is a defective bean, what types of defects it includes, etc., and for example, the probability of it being a completely black bean is 99%, the probability of being a fungus damaged bean is 80%, the probability of being a broken bean is 85%, which portion of it has insect damage holes, what is the probability determined for each insect damage hole; and based on the identification information, determines the comparison result of the at least one coffee bean C that indicates whether the coffee bean C is conforming. In response to determining the at least one coffee bean C is non-conforming, the processing unit 143 generates a removal signal for the non-conforming coffee bean C. It is hereby noted that the aforesaid non-conforming coffee bean C is meant to include not only foreign matter and defective beans, if the coffee bean sorting system 1 of the present disclosure is applied to grading, but also coffee beans that fail to meet a grade standard.

In certain embodiments, when using a model that is not learned by the processing unit 143, or information, such as a model, that is not obtained by learning, the computing module 1432 can input the bottom-side initial image into a coffee bean model and parameters that are manually inputted in advance, output the identification information of the coffee bean C, and based on the identification information, determine the comparison result of the at least one coffee bean C that indicates whether the coffee bean C is conforming. In certain embodiments, the processing unit 143 can, after determining the at least one coffee bean C as non-conforming, wait for a predetermined time interval, and generate and send the removal signal corresponding to the non-conforming coffee bean C to the removal mechanism 15 so that the non-conforming coffee bean C, when located within the removing range of the removal mechanism 15, can be removed by the removal mechanism 15 in time. In certain embodiments, the processing unit 143 can receive from the image capture device(s) 13 and/or 16 first time information that indicates the time at which the non-conforming coffee bean C moved past the image capture device(s) 13 and/or 16, and time interval information that is stored in the information processing device 14 and indicates the time required for the rotary disk to rotate from a first position corresponding to the image capture device(s) 13 and/or 16 to the removal mechanism 15, and can calculate according to the first time information and the time interval information second time information, second time information indicating the time at which the non-conforming coffee bean C arrives at the removing range of the removal mechanism 15. The processing unit 143 can also send the removal signal including the second time information to the removal mechanism 15.

Referring again to FIG. 1, the removal mechanism 15 can receive the removal signal sent by the information processing device 14 and corresponding to the non-conforming coffee bean C, and remove the non-conforming coffee bean C. In certain embodiments, after receiving from the processing unit 143 the removal signal including the second time information, the removal mechanism 15 waits according to the second time information until the arrival time of the non-conforming coffee bean C and then operates to remove the coffee bean C. In certain embodiments, the removal mechanism 15 is located on the rotary disk 12 and is a nozzle that can eject air to blow the non-conforming coffee bean C off the rotary disk 12. However, the present disclosure is not limited thereto. In certain embodiments, the removal mechanism 15 may be a negative-pressure suction device, may be located in an area above the top surface of the rotary disk 12, and can suck the non-conforming coffee bean C away from the rotary disk 12. Or the removal mechanism 15 may be a push-away device (e.g., a push rod or a linear actuation device) so as to push the non-conforming coffee bean C away from the rotary disk 12. Any removal mechanism 15 that can remove a non-conforming coffee bean C according to the removal signal is the removal mechanism 15 defined in the present disclosure.

Moreover, as the bottom-side initial image is only the bottom side of the coffee bean C, if a defective area is located at the top surface of the coffee bean, it cannot be identified. Therefore, in order to increase the correct rate of coffee bean identification, in certain embodiments, with continued reference to FIG. 1, the coffee bean sorting system 1 may be further provided with an image capture device above the top surface of the rotary disk 12 as the upper image capture device 16. The upper image capture device 16 can also capture an initial image (hereinafter referred to as the top-side or second initial image) of a coffee bean C, wherein the upper image capture device 16 may correspond to the position of the lower image capture device 13 (as shown in FIG. 1) but is not limited thereto; a manufacturer may adjust the position of the upper image capture device 16 according to practical needs such that it does not correspond to the lower image capture device 13. In addition, the upper image capture device 16 will send the top-side initial image to the information processing device 14 in order for the processing unit 143 to compare the top-side initial image against the coffee bean model and parameters and, after determining the coffee bean C as non-conforming, generate a corresponding removal signal so that the removal mechanism 15 can remove the aforesaid non-conforming coffee bean C.

Furthermore, a coffee bean C, once transported from the feeding mechanism 11 to the rotary disk 12, tends to roll on the rotary disk 12 because of its elliptical shape. Therefore, in order for a coffee bean C to be at a predetermined position and thereby make it easy for the lower image capture device 13 and the upper image capture device 16 to take images, with continued reference to FIG. 1, the coffee bean sorting system 1 further includes an aligning device 17. The aligning device 17 will be located on the rotary disk 12 and can bring the coffee beans C transported from the feeding mechanism 11 into alignment, allowing a plurality of coffee beans C to be separated from one another and form a succession. In certain embodiments, the aligning device 17 is at least one baffle plate. The baffle plate is disposed at an angle with an output opening of the feeding mechanism 11 (i.e., the position where coffee beans C are outputted). When a coffee bean C rolls onto the rotary disk 12 and collides with the baffle plate, it will be blocked by the baffle plate and hence change the rolling direction. At this time, with the rotation of the rotary disk 12, adjacent coffee beans C can be separated from one another and form a succession. However, in certain embodiments, the aligning device 17 also may be at least one roller. The roller will also be disposed at an angle with the output opening of the feeding mechanism 11, and when coffee beans C contact the roller, they can be pushed by the roller and rotated by the rotary disk 12 such that they are also separate from one another and form a succession.

With continued reference to FIG. 1, the coffee bean sorting system 1 further includes a discharge mechanism 18 that can receive the conforming coffee beans C transferred from the rotary disk 12. In certain embodiments, the discharge mechanism 18 is configured as a track with a baffle plate so that conforming coffee beans C can be blocked by the baffle plate and enter the track sequentially. However, the present disclosure is not limited thereto. As long as a discharge mechanism can transport the (conforming) coffee beans on the rotary disk 12 to an area expected by the manufacturer, it is the discharge mechanism 18 referred to in the present invention.

Moreover, with continued reference to FIG. 1, while the rotation of the rotary disk 12 can keep a plurality of coffee beans C spaced apart, if too many coffee beans C fall onto the rotary disk 12 almost at the same time, adjacent coffee beans C will be relatively close to one another, making it difficult to perform the subsequent image taking and identification (e.g., two coffee beans C may be mistaken as one coffee bean C). Hence, the coffee bean sorting system 1 is further provided with a pre-sorting device 10. The pre-sorting device 10 is adjacent to the feeding mechanism 11 and can adjust the time at which each coffee bean C falls onto the rotary disk 12, in order to control the timing and quantity of the coffee beans C falling onto the rotary disk 12, thereby adjusting the spacing between the coffee beans C. It is noted that the term “adjacent” refers to a range that is sufficient for the pre-sorting device 10 to keep the coffee beans C in the feeding mechanism 11 from falling onto the rotary disk 12; therefore, regardless of where the pre-sorting device 10 is specifically provided, as long as it can achieve the aforesaid effects, it falls within the range of “adjacent” as referred to in the present invention. Also, in certain embodiments, the pre-sorting device 10 may be formed at least by a detection unit 101 (e.g., an infrared detection unit) and a sorting unit 102 (e.g., a nozzle or a linear actuation device). The detection unit 101 may be provided on the feeding mechanism 11 and can detect that a coffee bean C is moving past itself, such as passing through the detection unit 101 or passing in front of the detection unit 101. The pre-sorting device 10 can, in response to detecting that a coffee bean C moves past itself, operate for a period of time to prevent any coffee bean from moving past the pre-sorting device 10 during that period of time. For example, activating the sorting unit 102, if the sorting unit 102 is a nozzle, to continuously eject air for 1 second, or if the sorting unit 102 is an actuating arm, to block the remaining beans behind the coffee bean C for a period of time, such as 1 second. Thus, within one second after the first coffee bean is detected, there will be no coffee beans moving past the pre-sorting device 10. The sorting unit 102 may be provided with a microchip so that it can, in response to receiving a detection signal from the detection unit 101, be activated and operate.

In certain embodiments, a detection unit may be provided adjacent to the circular disk and can determine whether the spacing between the coffee beans C on the circular disk is smaller than or equal to a threshold value. In response to determining the spacing as smaller than or equal to the threshold value, the detection unit generates and sends an operating signal to the pre-sorting device 10 in order for the pre-sorting device 10 to operate for a period of time. In certain embodiments, the length of the operating period may be manually inputted in and adjusted through the pre-sorting device 10, or adjusted through the mediation of the information processing device 14.

In certain embodiments, the detection unit 101 can detect the number of coffee beans C moving past itself in a period of time (e.g., 1 second), such as passing through the detection unit 101 or passing in front of the detection unit 101; and based on each of the aforesaid numbers of coffee beans C, generate a detection signal corresponding to the number; and send each detection signal to the information processing device 14 or the microchip on the sorting unit 102.

Continued from the above, referring back to FIG. 1, the information processing device 14 or the microchip on the sorting unit 102 will determine, according to the detection signal received, whether the number of coffee beans C moving past the detection unit 101 in that period of time is higher than or equal to a threshold value (e.g., 5 pieces). The larger the number of coffee beans C that move past in that period of time, the shorter the spacing between the coffee beans C. Moreover, when the information processing device 14 determines that the number of all the coffee beans C moving past the detection unit 101 in that period of time is higher than or equal to the threshold value, the information processing device 14 will, in response to the aforesaid determination result, generate and send a sorting message to the sorting unit 102. Then, the sorting unit 102 will, based on the sorting message or its own determination that the number of coffee beans C moving past the detection unit 101 in that period of time is higher than or equal to the threshold value, remove the aforesaid at least one coffee bean C moving past the detection unit 101 (e.g., by blowing it back to the vibrating table (the feeding mechanism 11) or another collecting area), preventing the aforesaid coffee bean C from falling onto the rotary disk 12, thereby ensuring that each coffee bean C on the rotary disk 12 can maintain an ideal spacing. That is, in the aforesaid embodiments, the detection signal generated by the detection unit 101 can be transmitted to the information processing device 14, however, the present disclosure is not limited thereto. In certain embodiments, it is also feasible for the pre-sorting device 10 itself to have the ability of determination. For example, the microchip provided to the sorting unit 102 can receive the aforesaid detection signal and perform the determination. Therefore, as long as a pre-sorting device 10 is sufficient for dynamic adjustment of the time at which coffee beans C fall onto the rotary disk 12, it is the pre-sorting device 10 referred to in the present invention.

It can be known from the above that since the coffee bean sorting system 1 in the present disclosure adopts the rotary disk 12, and the rotary disk 12 and the feeding mechanism 11 are two independent devices that do not interfere with each other, a coffee bean C can, after being transported to the rotary disk 12, remain in a still or nearly still state on the rotary disk 12, making it easy for the lower image capture device 13, the upper image capture device 16 to take clear images of the coffee bean. In addition, the coffee bean sorting system 1 can train the information processing device 14 with machine learning or deep learning in order to identify the related features of coffee beans, wherein the most basic use of machine learning is to use a large amount of data and algorithms to analyze data and thereby “train” the machine to learn from it, whereas deep learning further employs an artificial neural network with a large number of layers so that the machine can learn by itself through the artificial neural network to find important feature information. Either of machine learning and deep learning can, in terms of the result of the subsequent identification of coffee beans C, effectively supplement the deficiency and efficiency of human-based identification and hence grab users' attention. Moreover, the spatial area of the rotary disk 12 of the present invention is wider than the spirally inclined surface of the prior art. Therefore, a manufacturer can install the needed number of image capture devices 13, 16 and removal mechanism 15 in the aforesaid spatial area, and when the aforesaid devices or mechanism malfunctions or needs inspection or repair, a worker also has a relatively ample space for operation.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. A coffee bean sorting system having a rotary disk, including:
a feeding mechanism, configured to transport a plurality of coffee beans thereon;
the rotary disk, configured to receive the plurality of coffee beans transported from the feeding mechanism, and rotate along an axis thereof such that the plurality of coffee beans transported from the feeding mechanism are spaced apart from each other so as to be separate from each other and form a succession;
at least one image capture device, configured to capture an initial image of each of the plurality of coffee beans;
a first information processing device, configured to receive the initial image sent from the image capture device, and including:
an image database, including a plurality of coffee bean models and a plurality of parameters; and
a processing unit including at least one computing module, the computing module being configured to input the initial image in the plurality of coffee bean models and a plurality of parameters to output a comparison result, determine whether the each of the plurality of coffee beans is conforming based on the comparison result, and in response to determining at least one coffee bean is non-conforming, generate a removal signal corresponding to the non-conforming coffee bean; and
at least one removal mechanism, configured to receive the removal signal sent from the information processing device, so as to remove the non-conforming coffee bean.

2. The system according to claim 1, further including a learning module located in the first information processing device or a second information processing device and configured to perform machine learning training or deep learning training to generate a model identifying the non-conforming coffee bean.

3. The system according to claim 1, wherein the rotary disk is transparent.

4. The system according to claim 3, further including a pre-sorting device, the pre-sorting device being adjacent to the feeding mechanism, and configured to adjust the time at which the each coffee bean falls onto the rotary disk.

5. The system according to claim 4, the pre-sorting device further including:
a detection unit, configured to detect whether a coffee bean moves past the detection unit, and in response to detecting the coffee bean moving past the detection unit, generate a detection signal; and
a sorting unit, configured to receive the detection signal, and in response to receiving the detection signal, operate for a period of time to remove any coffee bean moving past the pre-sorting device during the period of time.

6. The system according to claim 3, wherein the image capture device is located under a bottom side of the rotary disk as a lower image capture device, and the lower image capture device is configured to capture the initial image of the coffee bean through the rotary disk, the initial image being a bottom-side initial image.

7. The system according to claim 3, wherein the image capture device is located above a top surface of the rotary disk as an upper image capture device, and the upper image capture device is configured to capture the initial image of the coffee bean, the initial image being a top-side initial image.

8. The system according to claim 4, wherein the image capture device is located above a top surface of the rotary disk as an upper image capture device, and the upper image capture device is configured to capture the initial image of the coffee bean, the initial image being a top-side initial image.

9. The system according to claim 5, wherein the image capture device is located above a top surface of the rotary disk as an upper image capture device, and the upper image capture device is configured to capture the initial image of the coffee bean, the initial image being a top-side initial image.

10. The system according to claim 7, further including an aligning device, the aligning device being located on the rotary disk, and configured to bring the coffee beans transported from the feeding mechanism into alignment and space apart the plurality of coffee beans from each other to form the succession.

11. The system according to claim 8, further including an aligning device, the aligning device being located on the rotary disk, and configured to bring the coffee beans transported from the feeding mechanism into alignment and space apart the plurality of coffee beans from each other to form the succession.

12. The system according to claim 9, further including an aligning device, the aligning device being located on the rotary disk, and configured to bring the coffee beans transported from the feeding mechanism into alignment and space apart the plurality of coffee beans from each other to form the succession.

13. The system according to claim 10, wherein the aligning device includes at least one baffle plate disposed at an angle with an output opening of the feeding mechanism so that the coffee beans are blocked by the baffle plate and rotated by the rotary disk to be separate from each other to form the succession.

14. The system according to claim 11, wherein the aligning device includes at least one baffle plate disposed at an angle with an output opening of the feeding mechanism so that the coffee beans are blocked by the baffle plate and rotated by the rotary disk to be separate from each other to form the succession.

15. The system according to claim 12, wherein the aligning device includes at least one baffle plate disposed at an angle with an output opening of the feeding mechanism so that the coffee beans are blocked by the baffle plate and rotated by the rotary disk to be separate from each other to form the succession.

16. The system according to claim 10, wherein the aligning device includes at least one roller disposed at an angle with an output opening of the feeding mechanism so that the coffee beans are pushed by the roller and rotated by the rotary disk to be separate from each other to form the succession.

17. The system according to claim 11, wherein the aligning device includes at least one roller disposed at an angle with an output opening of the feeding mechanism so that the coffee beans are pushed by the roller and rotated by the rotary disk to be separate from each other to form the succession.

18. The system according to claim 12, wherein the aligning device includes at least one roller disposed at an angle with an output opening of the feeding mechanism so that the coffee beans are pushed by the roller and rotated by the rotary disk to be separate from each other to form the succession.

19. The system according to claim 10, wherein the removal mechanism is located on the rotary disk.

20. The system according to claim 11, wherein the removal mechanism is located on the rotary disk.

21. The system according to claim 12, wherein the removal mechanism is located on the rotary disk.

22. The system according to claim 19, further including a discharge mechanism configured to receive at least one coffee bean conforming to the standard.

23. The system according to claim 20, further including a discharge mechanism configured to receive at least one coffee bean conforming to a standard.

24. The system according to claim 21, further including a discharge mechanism configured to receive at least one coffee bean conforming to a standard.

25. The system according to claim 22, wherein the removal mechanism includes a nozzle and is configured to eject air to blow the non-conforming coffee bean off the rotary disk.

26. The system according to claim 23, wherein the removal mechanism includes a nozzle and is configured to eject air to blow the non-conforming coffee bean off the rotary disk.

27. The system according to claim 24, wherein the removal mechanism includes a nozzle and is configured to eject air to blow the non-conforming coffee bean off the rotary disk.

28. The system according to claim 22, wherein the removal mechanism includes a negative-pressure suction device and is configured to suck the non-conforming coffee bean away from the rotary disk.

29. The system according to claim 23, wherein the removal mechanism includes a negative-pressure suction device and is configured to suck the non-conforming coffee bean away from the rotary disk.

30. The system according to claim 24, wherein the removal mechanism includes a negative-pressure suction device and is configured to suck the non-conforming coffee bean away from the rotary disk.

31. The system according to claim 22, wherein the removal mechanism includes a push-away device and is configured to push the non-conforming coffee bean away from the rotary disk.

32. The system according to claim 23, wherein the removal mechanism includes a push-away device and is configured to push the non-conforming coffee bean away from the rotary disk.

33. The system according to claim 24, wherein the removal mechanism includes a push-away device and is configured to push the non-conforming coffee bean away from the rotary disk.
